(19) United States
(12) Patent Application Publication
(10) Pub. No.: US 2015/0057912 A1
(43) Pub. Date: Feb. 26, 2015

(54) VEHICLE CARBON MONOXIDE DETECTION SYSTEM AND METHOD

(71) Applicant: FORD GLOBAL TECHNOLOGIES, LLC, Dearborn, MI (US)

(72) Inventors: Walt Joseph Ortmann, Saline, MI (US); Robert Wright, Royal Oak, MI (US)

(21) Appl. No.: 14/010,121

(22) Filed: Aug. 26, 2013

(51) Int. Cl. F02D 41/02

(52) U.S. Cl. CPC F02D 41/02
USPC 701/112

(57) ABSTRACT

A vehicle carbon monoxide detection system for a vehicle includes a vehicle internal combustion engine; a controller interfacing with the vehicle internal combustion engine; a carbon monoxide sensor interfacing with the controller, the carbon monoxide sensor adapted to detect a level of carbon monoxide. The controller is adapted to prevent and terminate operation of the vehicle internal combustion engine if the level of carbon monoxide detected by the carbon monoxide sensor exceeds a threshold carbon monoxide level. A vehicle and a vehicle carbon monoxide detection method are also disclosed.

### FIELD

Illustrative embodiments of the disclosure relate to hybrid electric vehicles (HEVs). More particularly, illustrative embodiments of the disclosure relate to a carbon monoxide detection system and method for hybrid electric vehicles.

### BACKGROUND

Electrical generators are commonly used as a mobile source of electrical power for electrical accessories. Frequently, electrical generators may be carried on trucks and other vehicles to provide electrical power for accessories used by contractors, campers and upfitters and the like. However, electrical generators, as well as the internal combustion engine of HEVs, may generate carbon monoxide during use. In closed or unventilated areas, it may be desirable or necessary to monitor the carbon monoxide levels during operation of an HEV or an electrical generator which is carried by the HEV.

Accordingly, a carbon monoxide detection system and method for hybrid electric vehicles may be desirable.

### SUMMARY

Illustrative embodiments of the disclosure are generally directed to a vehicle carbon monoxide detection system for a vehicle. An illustrative embodiment of the system includes a vehicle internal combustion engine; a controller interfacing with the vehicle internal combustion engine; a carbon monoxide sensor interfacing with the controller, the carbon monoxide sensor adapted to detect a level of carbon monoxide. The controller is adapted to prevent and terminate operation of the vehicle internal combustion engine if the level of carbon monoxide detected by the carbon monoxide sensor exceeds a threshold carbon monoxide level.

Illustrative embodiments of the disclosure are further generally directed to a vehicle. An illustrative embodiment of the vehicle includes a vehicle chassis, a vehicle internal combustion engine carried by the vehicle chassis, an electric motor drivingly engaged by the vehicle internal combustion engine and at least one wheeled drive axle drivingly engaged by the vehicle internal combustion engine. A vehicle carbon monoxide detection system includes a vehicle internal combustion engine; a controller interfacing with the vehicle internal combustion engine; and a carbon monoxide sensor interfacing with the controller. The carbon monoxide sensor is adapted to detect a level of carbon monoxide. The controller is adapted to prevent and terminate operation of the vehicle internal combustion engine if the level of carbon monoxide detected by the carbon monoxide sensor exceeds a threshold carbon monoxide level.

Illustrative embodiments of the disclosure are further generally directed to a vehicle carbon monoxide detection method. An illustrative embodiment of the method includes generating electrical power from an electric motor by operating a vehicle internal combustion engine drivingly engaging the electric motor, monitoring ambient levels of carbon monoxide around a vehicle, comparing a detected level of carbon monoxide to a threshold carbon monoxide level and neutralizing operation of a vehicle internal combustion engine if the detected level of carbon monoxide exceeds the threshold carbon monoxide level.

### BRIEF DESCRIPTION OF THE DRAWINGS

Illustrative embodiments of the disclosure will now be described, by way of example, with reference to the accompanying drawings, in which:

FIG. 1 is a block diagram of an HEV which includes an illustrative embodiment of the vehicle carbon monoxide detection system; and

FIG. 2 is a flow diagram of an illustrative embodiment of a vehicle carbon monoxide detection method.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is non-limiting and is not necessarily to be construed as preferred or advantageous over other implementations. All of the implementations described below are exemplary implementations provided to enable persons skilled in the art to practice the disclosure and are not intended to limit the scope of the appended claims. Moreover, the illustrative embodiments described herein are not exhaustive and embodiments or implementations other than those which are described herein and which fall within the scope of the appended claims are possible. Furthermore, there is no intention to be bound by any expressed or implied theory presented in the preceding technical field, background, brief summary or the following detailed description.

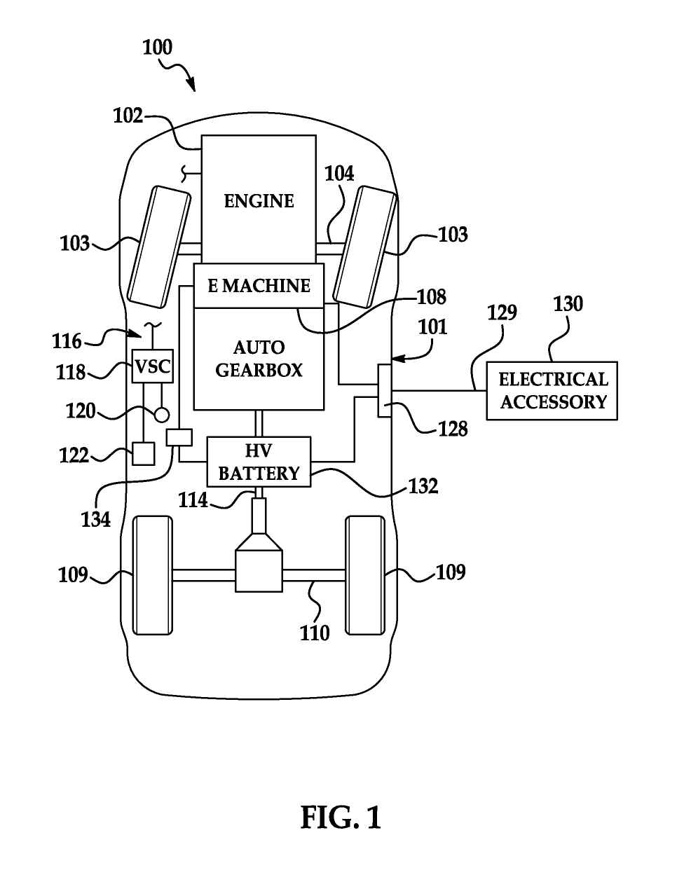

Referring initially to FIG. 1, an illustrative embodiment of the vehicle carbon monoxide detection system, hereinafter system, is generally indicated by reference numeral 116. The system 116 may be suitable for implementation in conjunction with an electric vehicle 100 such as a hybrid electric vehicle (HEV), for example and without limitation. Generally, the electric vehicle 100 may include a vehicle chassis 101 having a front drive axle 104 and a rear drive axle 110. The front drive axle 104 may be fitted with a pair of front wheels 103. The rear drive axle 110 may be fitted with a pair of rear wheels 109.

An internal combustion engine 102 may drivingly engage at least one of the front drive axle 104 and the rear drive axle 110. An electric motor (E machine) 108 may be drivingly engaged by the engine 102. A rechargeable vehicle battery 132 may be connected to the electric motor 108 via an inverter 134. The vehicle battery 132 may be capable of being recharged with electrical power at a charging destination (not shown) via suitable plug-in electrical equipment, as is known to those skilled in the art. The electric vehicle 100 may be adapted for propulsion by the front wheels 103 via the front drive axle 104 and/or by the rear wheels 109 via the rear drive axle 110 through engagement of the internal combustion engine 102. The electric vehicle 100 may additionally or alternatively be adapted for propulsion by the front drive wheels 103 via the front drive axle 104 and/or by the rear wheels 109 via the rear drive axle 110 through engagement of the electric motor 108. A drive shaft 114 may drivingly connect the internal combustion engine 102 and the E machine 108 to the rear drive axle 110.

A generator port 128 may electrically interface with the vehicle battery 132. The generator port 128 may additionally interface with the electric motor 108. The generator port 128 may be provided on the exterior of the vehicle chassis 101 or in any other suitable location inside or outside the vehicle 100. A power cord 129 may electrically interface with the generator port 128. In some embodiments, the power cord 129 may be selectively extendable and retractable with respect to the generator port 128. In other embodiments, the generator port 128 may be fitted with an electrical outlet (not shown) into which the power cord 129 can be plugged. Accordingly, the power cord 129 may be part of an electrical accessory 130 which is external to the vehicle 100 and can be powered by operation electrical current from the vehicle battery 132.

The electrical accessory 130 may include an electrically-powered tool, apparatus or any electrically-operated system which requires an external source of electrical power. In some applications, the electrical accessory 130 may include a building or other structure which is in need of electrical power. A VSC (vehicle system controller) 118 can operate the vehicle 100 in an electrical generator mode in which the vehicle transmission is placed in park. The engine 102 drives the electric motor 108, which generates electrical power that is routed to the generator port 128 and to the vehicle battery 132. The generated electrical power which is routed to the generator port 128 is distributed to the electrical accessory 130 through the power cord 129. The generated electrical power which remains is routed to the vehicle battery 132 and maintains the SOC (state of charge) of the vehicle battery 132. Once the SOC of the vehicle battery 132 is full, the VSC 118 may automatically terminate operation of the engine 102. The vehicle battery 132 may then provide electrical power to the electrical accessory 130 through the generator port 128 and the power cord 129. After the SOC of the vehicle battery 132 is depleted to a low level, the VSC 118 again operates the engine 102 to again replete the SOC of the vehicle battery 132.

A vehicle carbon monoxide (CO) detection system 116 is onboard the vehicle chassis 101 of the vehicle 100. The vehicle CO detection system 116 may include a controller such as the VSC (Vehicle System Controller) 118 for the vehicle 100. The VSC 118 may interface with the internal combustion engine 102 for control thereof. A CO sensor 120 interfaces with the VSC 118. In some embodiments, at least one audible and/or visual alarm 122 may interface with the VSC 118. The alarm 122 may be provided on the exterior of the vehicle chassis 101 or in any other suitable location inside or outside the vehicle 100.

The CO sensor 120 of the vehicle CO detection system 116 may be adapted to detect the concentration or level of carbon monoxide in the air around the vehicle 100. The CO sensor 120 may be further adapted to transmit the measured level of carbon monoxide to the VSC 118. The VSC 118 may be programmed to store a threshold CO level and compare the measured level of carbon monoxide which was received from the CO sensor 120 to the threshold CO level. The VSC 118 may be programmed to prevent operation or terminate further operation of the internal combustion engine 102 in the electric generator mode in the event that the VSC 118 determines that the measured level of carbon monoxide exceeds the threshold CO level. In some embodiments, the VSC 118 may be further programmed to activate the alarm 122 in the event that the VSC 118 determines that the measured level of carbon monoxide exceeds the threshold CO level.

In exemplary application of the system 116, the electrical accessory 130 may be a home, business or other building or structure which is in need of electrical power. The vehicle 100 may be parked in a garage or other enclosed or semi-enclosed space (not shown) adjacent to the building or structure. The electrical accessory 130 may be electrically connected to the generator port 128 through the power cord 129. The engine 102 is operated to drive the electric motor 108, which produces electrical current which flows to the electrical accessory 130 through the generator port 128 and the power cord 129 to operate the electrical accessory 130. Remaining electrical current flows to the vehicle battery 132 through the inverter 134 to maintain the SOC of the vehicle battery 132. When the SOC of the vehicle battery 132 is replenished, the VSC 118 may terminate further operation of the engine 102. The vehicle battery 132 may continue to provide electrical current to the electrical accessory 130 through the generator port 128 and the power cord 129. As the vehicle 100 remains parked for extended periods of time, the VSC 118 may periodically operate the internal combustion engine 102 to produce electrical current which maintains the state of charge (SOC) of the vehicle battery 132.

During its operation, the engine 102 may produce carbon monoxide which may accumulate in the garage or other enclosed area in which the vehicle 100 is parked. Accordingly, the CO sensor 120 monitors the level, concentration or quantity of carbon monoxide in the area which surrounds the vehicle 100. In the event that it determines that the measured level of carbon monoxide exceeds the threshold CO level, the VSC 118 prevents operation or terminates further operation of the engine 102. Therefore, the ambient levels of carbon dioxide in the area of the vehicle 100 may fall to levels which are safe for persons in the area of the vehicle 100. In some embodiments, the VSC 118 may additionally activate the alarm 122 to alert persons in the vicinity of the vehicle 100 to the presence of the carbon monoxide levels around the vehicle 100. This may warn persons to stay away from the vehicle 100 or notify an owner or operator of the vehicle 100 or other person to take corrective measures for reduction of the carbon dioxide levels.

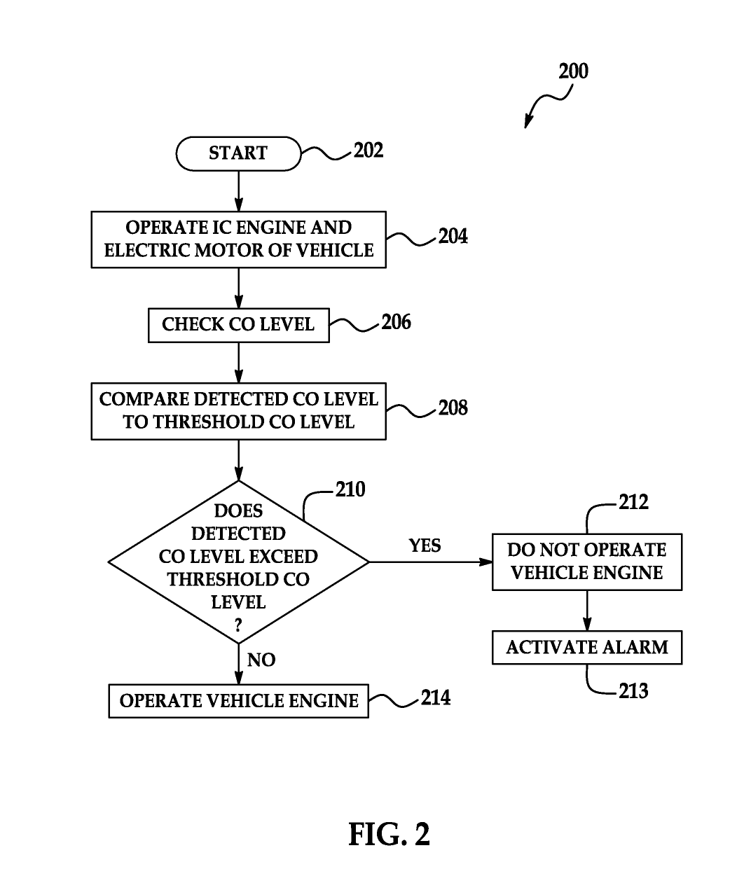

Referring next to FIG. 2, a flow diagram 200 of an illustrative embodiment of a vehicle carbon monoxide detection method is shown. The method begins at block 202. In block 204, an internal combustion vehicle engine of a hybrid electric vehicle (HEV) may be operated. The vehicle engine drives an electric motor which is coupled to the engine. The electric motor generates electrical power that for an electrical accessory and maintains SOC of a vehicle battery. In block 206, carbon monoxide levels in the area around the HEV may be monitored.

In block 208, the detected CO level may be compared to a threshold CO level. In the event that the detected CO level exceeds the threshold CO level in block 210, operation of the vehicle engine may be neutralized (prevented or terminated) in block 212. An alarm may additionally be activated in block 213. In the event that the detected CO level does not exceed the threshold level in block 210, the vehicle engine is periodically operated in block 214 to maintain the state of charge (SOC) of the vehicle battery in the HEV.

Although the embodiments of this disclosure have been described with respect to certain exemplary embodiments, it is to be understood that the specific embodiments are for purposes of illustration and not limitation, as other variations will occur to those of skill in the art.

What is claimed is:

1. A vehicle carbon monoxide detection system for a vehicle, comprising:
a vehicle internal combustion engine;
a controller interfacing with the vehicle internal combustion engine;
a carbon monoxide sensor interfacing with the controller, the carbon monoxide sensor adapted to detect a level of carbon monoxide; and
the controller adapted to prevent and terminate operation of the vehicle internal combustion engine if the level of carbon monoxide detected by the carbon monoxide sensor exceeds a threshold carbon monoxide level.

2. The system of claim 1 further comprising at least one alarm interfacing with the controller.

3. The system of claim 2 wherein the at least one alarm comprises at least one audible alarm.

4. The system of claim 2 wherein the at least one alarm comprises at least one visual alarm.

5. The system of claim 2 wherein the controller comprises a vehicle system controller.

6. The system of claim 1 wherein the vehicle internal combustion engine comprises a hybrid electric vehicle internal combustion engine.

7. A vehicle, comprising:
a vehicle chassis;
a vehicle internal combustion engine carried by the vehicle chassis;
an electric motor drivingly engaged by the vehicle internal combustion engine;
at least one wheeled drive axle drivingly engaged by the vehicle internal combustion engine;
a vehicle carbon monoxide detection system including:
a vehicle internal combustion engine;
a controller interfacing with the vehicle internal combustion engine;
a carbon monoxide sensor interfacing with the controller, the carbon monoxide sensor adapted to detect a level of carbon monoxide; and
the controller adapted to prevent and terminate operation of the vehicle internal combustion engine if the level of carbon monoxide detected by the carbon monoxide sensor exceeds a threshold carbon monoxide level.

8. The vehicle of claim 7 further comprising at least one alarm interfacing with the controller.

9. The system of claim 8 wherein the at least one alarm comprises at least one audible alarm.

10. The system of claim 8 wherein the at least one alarm comprises at least one visual alarm.

11. The system of claim 8 wherein the controller comprises a vehicle stability control system.

12. The system of claim 8 wherein the vehicle internal combustion engine comprises a hybrid electric vehicle internal combustion engine.

13. The system of claim 7 wherein the at least one wheeled drive axle comprises a first wheeled drive axle drivingly engaged by the vehicle internal combustion engine, and further comprising a second wheeled drive axle and wherein the electric motor drivingly engages the second wheeled drive axle.

14. A vehicle carbon monoxide detection method, comprising:
generating electrical power from an electric motor by operating a vehicle internal combustion engine drivingly engaging the electric motor;
monitoring ambient levels of carbon monoxide around a vehicle;
comparing a detected level of carbon monoxide to a threshold carbon monoxide level; and
neutralizing operation of the vehicle internal combustion engine if the detected level of carbon monoxide exceeds the threshold carbon monoxide level.

15. The method of claim 14 further comprising activating at least one alarm if the detected level of carbon monoxide exceeds the threshold carbon monoxide level.

16. The method of claim 15 wherein activating at least one alarm comprises activating at least one audible alarm.

17. The method of claim 15 wherein activating at least one alarm comprises activating at least one visual alarm.

18. The method of claim 14 wherein neutralizing operation of a vehicle internal combustion engine comprises preventing operation of the vehicle internal combustion engine.

19. The method of claim 14 wherein neutralizing operation of a vehicle internal combustion engine comprises terminating operation of the vehicle internal combustion engine.

20. The method of claim 14 wherein generating electrical power from an electric motor comprises generating electrical power from an electric motor onboard a hybrid electric vehicle.
